(19) United States
(12) Patent Application Publication
(10) Pub. No.: US 2026/0057422 A1
(43) Pub. Date: Feb. 26, 2026

(54) SYSTEM AND METHOD FOR PROVIDING LANGUAGE PROCESSING MODEL SERVICES ON A NETWORK

(71) Applicant: Salesforce, Inc., San Francisco, CA (US)

(72) Inventors: Daryl Martis, New York, NY (US); Anubha Dubey, Sunnyvale, CA (US); Ashish Thapliyal, Frisco, TX (US); Manjeet Singh, Milpitas, CA (US); Kaushal Kurapati, Cupertino, CA (US)

(73) Assignee: Salesforce, Inc., San Francisco, CA (US)

(21) Appl. No.: 18/810,496

(22) Filed: Aug. 20, 2024

(51) Int. Cl. G06Q 30/0283; G06F 3/04842; G06Q 10/0631

(52) U.S. Cl. CPC G06Q 30/0283; G06F 3/04842; G06Q 10/0631

(57) ABSTRACT

Apparatus and method for recommending and configuring LLM models for organizations. For example, LLM model usage requirements of one or more organizations are evaluated, including applications and users associated with each organization. A cost estimation is performed with respect to expected utilization of the plurality of LLM models and a subset of LLM models is recommended for each of the organizations, applications, and users, along with rate limits for each organization and corresponding applications based on a global threshold rate limit specified for the entity. Upon acceptance by an administrator, the global threshold rate limit is partitioned into a corresponding set of per-organization threshold rate limits; each organization threshold rate limit is allocated to a corresponding organization of the one or more organizations, and each respective threshold rate limit is subdivided into portions to be allocated to applications of the respective organization.

### TECHNICAL FIELD

One or more implementations relate to the field of computer systems for providing data processing services; and more specifically, to a system and method for providing natural language processing services, such as large language model (LLM) services, on a network.

### BACKGROUND ART

Natural language processing (NLP) provides computing devices the ability to process data captured in a natural language format. The tasks performed by NLP systems include speech recognition, text classification, natural-language understanding, and natural-language generation. One particular type of NLP system, known as a large language model (LLM) system, has attracted considerable attention in recent years, largely due to the availability of services such which use LLMs (e.g., such as ChatGPT).

LLMs are deep learning models that are pre-trained using extensive data sets. LLMs are typically implemented with a set of neural networks that include an encoder and a decoder with self-attention detection and processing capabilities. The encoder and decoder are configured to extract meanings from text sequences and understand the relationships between words and phrases in the text sequences. Transformer LLMs are capable of unsupervised training, referred to as self-learning. Through this process, transformers learn basic grammar, languages, and acquire knowledge. Transformer LLMs process text sequences in parallel, utilizing the parallel processing capabilities of GPU architectures to significantly reduce training time. The neural network architectures used by transformer LLMs rely on extremely large models, with potentially hundreds of billions of parameters. Such large-scale models are capable of ingesting massive amounts of data from various sources, including the internet.

Some cloud-based software systems provide LLM services within existing cloud-based applications. One of the challenges with these implementations is that the LLM services can consume significant processing resources and network bandwidth, particularly if the LLM services are made available to all users of an organization (e.g., end users assigned various permission levels on the cloud-based software system, including administrators). There are currently no mechanisms for limiting the number of requests that can be made to an LLM service and no existing techniques for estimating the costs of implementing LLM models.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 illustrates an embodiment in which LLM models are assigned to multiple organizations.

FIG. 2 illustrates an embodiment of a cost estimator for estimating cost associated with LLM usage.

FIG. 3 illustrates an LLM assignment adviser for recommending usage of LLMs to a plurality of organizations, applications, and users.

FIG. 4 illustrates an example portion of a graphical user interface (GUI) for recommending LLMs for particular applications and for comparing existing LLM metrics to metrics for the recommended LLM.

FIGS. 5A-B illustrate example portions of a graphical user interface (GUI) for recommending LLMs for particular applications and for comparing existing LLM metrics to metrics for the recommended LLMs.

FIG. 6 illustrates a portion of a GUI for providing additional information related to an LLM (LLM1), including comparison data, and user interface features to modify RPM and/or token values.

FIG. 7A illustrates a method in accordance with embodiments of the invention for providing and accepting recommendations with respect to LLM models.

FIG. 7B illustrates one embodiment for reallocating spare requests per minute (RPM) or tokens per minute (TPM) resources.

FIG. 8A is a block diagram illustrating an electronic device according to some example implementations; and

FIG. 8B is a block diagram of a deployment environment according to some example implementations.

### DETAILED DESCRIPTION

A system and method in accordance with embodiments of this disclosure provide large language model (LLM) services to users of a cloud-based platform at various levels of granularity, including the organization (Org) level (e.g., all applications and users in a particular organization), the application level (e.g., particular applications in the organization), and the user level (e.g., individual users within the organization). For example, a predictive model is used in some implementations to provide suggestions regarding which of a set of available LLM models are the most appropriate for a given application and/or user, in view of user-specified or system-level constraints. In addition, at least some implementations provide techniques for rate limiting access to LLM services in accordance with defined thresholds or policies. These embodiments may perform sampling at configurable sampling rates to estimate the costs associated with different LLM models and provide user control over the maximum number of LLM-based events which can be processed within a given time window. Additionally, graphical user interface features provide visibility and control over all of these LLM integration features.

Note that the term “user” can refer to administrators, end-users, and any other users with varying permission levels within the cloud-based service platform. “Organizations” or “Orgs” may refer to different business entities such as different companies, different departments or divisions of a particular company, and/or other types of entities to which utilize the services of the cloud-based software platforms described herein, including the LLM models.

In accordance with these embodiments, LLM models and corresponding thresholds can be assigned at the organization level (e.g., all users of an organization or “org”), the application level (e.g., to all users of an application), and the user level (e.g., including specific users and specific categories of users, such as users within a particular department, branch, or division of the organization).

In some implementations, requests for LLM services are generated by applications, instances of which are executed or accessed from endpoint devices operated by users. A request may be initiated, for example, when a user enters or selects a block of text to be processed by the LLM services. The text is encoded into a sequence of tokens, which are the fundamental units of data processed by LLM models. A token can be encoded for any portion of the submitted text, such as a word, part of a word (subword), or a character, based on the tokenization process for the LLM model. The resulting tokens are specialized vectors which can be interpreted and processed by the LLM model. Tokens can also be decoded by a decoder to reproduce the submitted text.

At each of the different levels for assigning LLM services (e.g., organization, application, and user), rate limits may be enforced to limit access to the assigned LLM services based on specified thresholds. The rate limits may be specified, for example, in terms of Requests Per Minute (RPM) and Tokens Per Minute (TPM), although various other metrics may be used while still complying with the underlying principles described herein. These limits are configured for managing the load and ensuring efficient operation of the LLM models, thereby preventing overloading and ensuring that the corresponding LLM model can efficiently process incoming requests and provide responses.

As used herein, a threshold number of requests per minute (RPMs) and a corresponding threshold number of tokens per minute (TPM) can be sent to a given LLM model. In these implementations, different LLMs and different tiers within a given LLM may be assigned different thresholds. In some implementations, when both RPM and TPM thresholds are set, the threshold which is reached first will apply. By way of example, and not limitation, if RPM is 20 and TPM is 150,000 for a given user, and the user sends 20 requests using only 100 tokens, the user's limit is reached (even though the 150k token threshold was not reached). As another example, API calls to the highest tier of OpenAI's GPT-4 LLM model provides for limits of 10,000 RPM and 300,000 TPM.

The high cost of serving LLMs is a major challenge for widespread adoption. Running these models requires significant computational power, memory, and data transfer bandwidth, leading to higher costs. This can be a barrier for organizations, especially for tasks requiring frequent interactions or real-time responses.

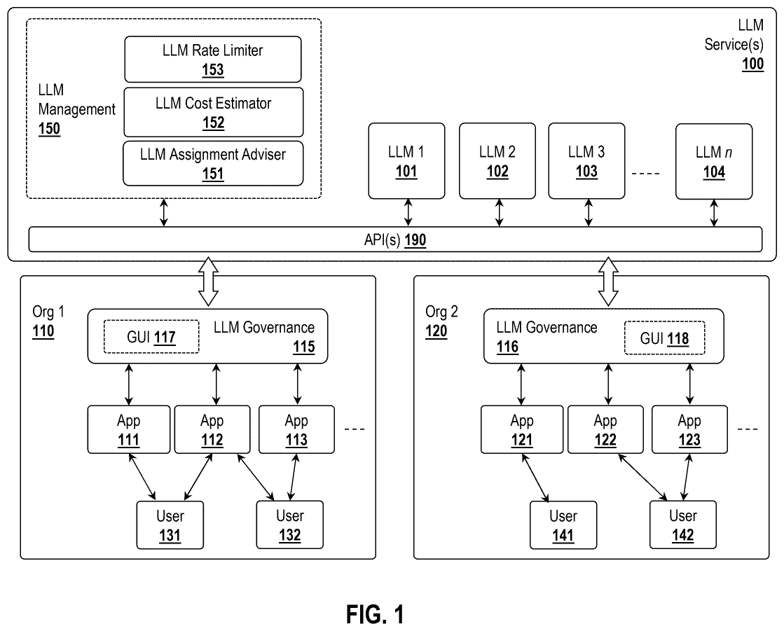

FIG. 1 illustrates an example using a first organization, Org1 110, and a second organization, Org2 120, which have controlled access to LLM services 100 through an LLM management engine 150. The first org 110 includes a first plurality of applications 111-113 accessed by a first plurality of users 131-132 and the second org 120 includes a second plurality of applications 121-123 accessed by a second plurality of users 141-142. In some implementations, user access to the LLM services 100 may be integrated within one or more of the applications 111-113, 121-123 (e.g., via links embedded in user interface elements of the respective application), which make calls to the LLM models 101-104 via one or more APIs 190 exposed by the LLM service(s) 100.

An LLM governance engine 115, 116 operable in each respective org 110, 120, regulates access to the LLM models 101-104 in accordance with embodiments of this disclosure. In particular, control and configuration information is managed by an LLM management engine 150. At least a portion of the control and configuration information may be input by an administrator (or other user) via a respective user interface (UI) 117-118 provided by a respective LLM governance engine 115, 116.

In the illustrated example, the LLM management engine 150 includes an LLM assignment adviser 151 for making LLM model recommendations for each org 110, 120, application 111-113, 121-123, and/or user 131-132, 141-142, as described further below. An LLM cost estimator 152 implements one or more of the techniques described herein to estimate the cost associated with usage of the various LLM models 101-104 and an LLM rate limiter 153 specifies limitations on accessing the various LLM models 101-104 by the orgs, applications, and/or users (e.g., in the form of requests per minute, tokens per minute, or by specifying other usage metrics).

In some implementations, before deploying an LLM model for access by applications 111-113, 121-123, the estimated cost to use the LLM model is determined. To evaluate the cost, metrics involving LLM calls may be continually monitored, collected, and evaluated in combination with the added hardware and/or software requirements (e.g., additional event storage and processing resources), to arrive at a cost estimate. In some implementations, events may be monitored and evaluated at different granularities. For example, using the finest available granularity, a maximum number of events are sampled and processed (e.g., all events), whereas using a coarser granularity, fewer events are sampled and processed. In these implementations, the event sampling rate is selected at the coarsest granularity required to provide a reasonable estimate (i.e., to reduce the load associated with storing and processing events).

In one implementation, the event sampling rate is configured based on the following metadata (or portions thereof):

| Parameter name | Description | Example values |
|---|---|---|
| Cadence | Frequency of metrics | 1 day, 1 hour, |
| | calculation | 1 minute |
| SamplingPercentage/ | Amount/percentage of | 5%/1000 |
| SamplingCount | events to keep | |
| WindowType | Type of window for | Thumbling/Sliding |
| | sampling | |
| WindowSize | Window Size (in units | 1 hour, 1 minute |
| | of time) | |

By way of example, and not limitation, with the cadence set to 1 day, the window type set to Thumbling, the Window Size set to 1 hour and the SamplingCount set to 1000, metrics are captured and evaluated once per day within a 1 hour window of time during which 1000 events will be stored.

Cost estimation may be performed in combination with cadence and sampling data collection. In some embodiments, each task which will utilize LLM services is categorized and, based on the categorization, the number of tokens required for a single task is statically estimated. For example, an email generation task may be estimated to require 700 tokens on average while an email categorization task may be estimated to require 20 tokens on average. These average estimated loads may be combined to categorize the task or to assign the task a numerical score indicating token consumption of the task relative to other tasks (e.g., a value of 3 on a scale of 1-10, where 10 indicates the highest estimated token consumption). Once the task has been categorized with respect to token consumption, the number of expected instances of the task are determined and used to generate a final cost value. For example, a small organization may process 50 requests per day and a large one 1000 requests per day. In accordance with these values, the load per day, week, and month can be estimated. Sampling may then be performed within the organization to collect metrics and determine the difference.

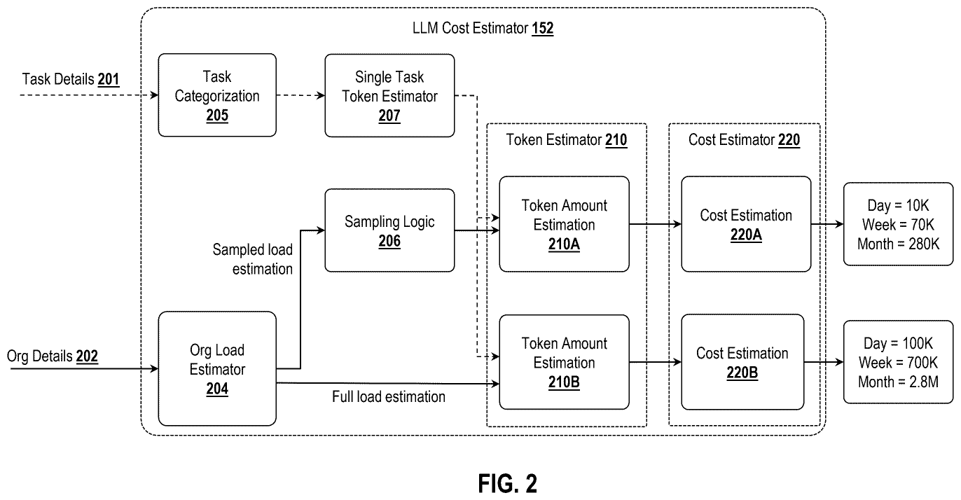

FIG. 2 illustrates an example LLM cost estimator 152 for generating cost estimations for LLM utilization which can be evaluated by an administrator to determine appropriate limits for the corresponding organization, applications, and/or users. Task details 201 include information related to the specific task(s) for which LLM models are to be utilized. Different tasks will require different levels of LLM complexity and corresponding token consumption rates. For example, for a simple task such as summarizing the contents of a text-based document (e.g., an email message or word processing document), a relatively small LLM model may be sufficient (corresponding to a relatively small number of tokens consumed). However, a more complex task such as one which requires understanding the underlying contents of the text-based document and generating a an accurate response requires a larger LLM model with a larger token consumption rate.

As mentioned, in these embodiments, the task may be categorized on a normalized numeric scale. Based on the task categorization, a single task token estimator 207 generates an estimate of the expected token usage for the task. While a single task token estimator 207 is shown generating an estimate for one particular task, multiple instances of the single task token estimator 207 may be run in parallel within the LLM cost estimator 152 when multiple different types of tasks are under evaluation. The results of all tasks may then be provided to the token estimator 210 (described further below).

A customer load estimator 204 generates an estimate of the anticipated load corresponding to the task at a particular organization. The organization load estimator 204 requests a sampled load estimation from sampling logic 206, which responsively samples running instances of the task within the organization and a full load estimation, representing the maximum potential load associated with the task.

A token estimator 210 includes first token amount estimation logic 210A which generates a first estimate based on the expected token usage for a single instance of the task (provided by the single task token estimator 207) and an estimated number of times the single task is executed, indicated by the sampling logic 206. Similarly, second token amount estimation logic 210B generates a second estimate based on the maximum potential load, corresponding to a maximum potential utilization of the task, in combination with the expected token usage for a single instance of the task. If multiple token estimates are provided for multiple different tasks, then additional token estimates may be generated for these tasks.

A cost estimator 220 then generates the expected cost based on the token estimates. For example, first cost estimation logic 220A generates an estimated cost for a single instance of the task (e.g., specified in a daily, weekly, and/or monthly cost value) and second cost estimation logic 220B generates an estimated cost for a maximum potential task utilization (also specified in a daily, weekly, and/or monthly cost value). In these embodiments, the estimated cost may be specified as the estimated number of tokens per unit of time such as: average number of requests * average tokens per request. Both sets of estimates may be provided to an administrator who can then configure LLM utilization thresholds via one of the UIs 117-118 of a respective LLM governance engine 115-116, based on the estimates and various other limitations as described herein.

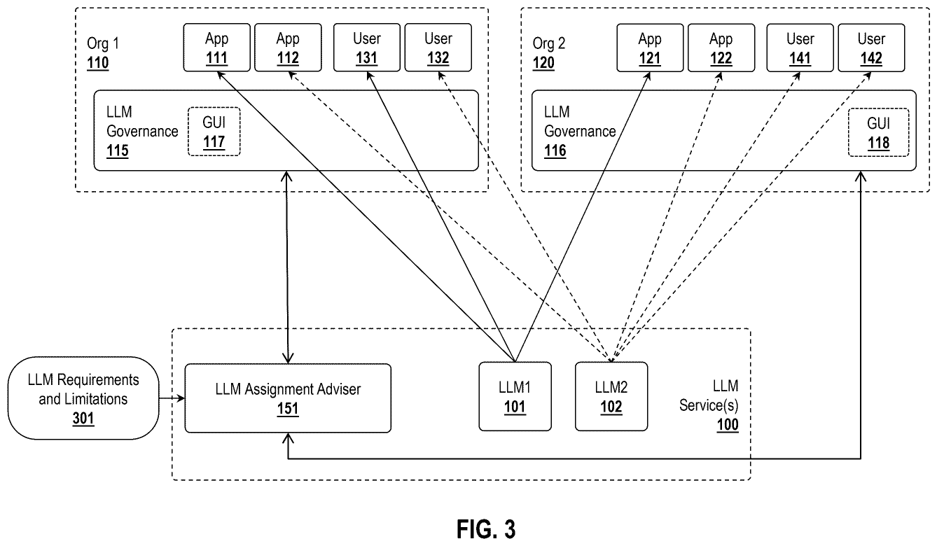

As illustrated in FIG. 3, each organization 110, 120 accesses the LLM assignment adviser 151 via a respective LLM governance engine 115, 116. The LLM assignment adviser 151 evaluates the LLM requirements and limitations 301 specified for each organization 110, 120, application 111-112, 121, 122, and/or user 131-132, 141-142, to make recommendations for mapping LLM models 101-102 to each respective organization, application, and user. The LLM requirements and limitations 301, or a subset thereof, may be specified by an administrator via one of the UIs 117-118. In the illustrated example, a mapping of LLM1 101 to applications 111, 121, and user 131, and a mapping of LLM2 102 to applications 112, 122, and users 141-142 is recommended by the LLM assignment adviser 151 based on the LLM usage requirements 301. In addition to recommending specific mappings of LLM models 101-102 to organizations, applications, and users, the LLM assignment adviser 151 may also recommend specific rate limits for each organization, application, and/or user. In these embodiments, the LLM assignment adviser 151 may generate its rate limit recommendations based on various input parameters, some of which may be explicitly specified (e.g., by the administrator) and others of which may be implied. With respect to application allocations and/or user allocations within an organization, for example, the input parameters may include the industry or sub-industry of the organization, the geographical region or language associated with the organization, the number of employees, the current products offered by the organization, the current budget of the organization, and knowledge of any previous assignments to LLMs, all or a portion of which may be provided in the LLM usage requirements and limitations 301.

In some embodiments, the LLM governance engines 115-116 may automatically select the recommendations generated by the LLM assignment adviser 151. In other embodiments, the recommendations are first presented to an administrator via a respective UI 117-118, who can then accept the recommendations (potentially after making adjustments).

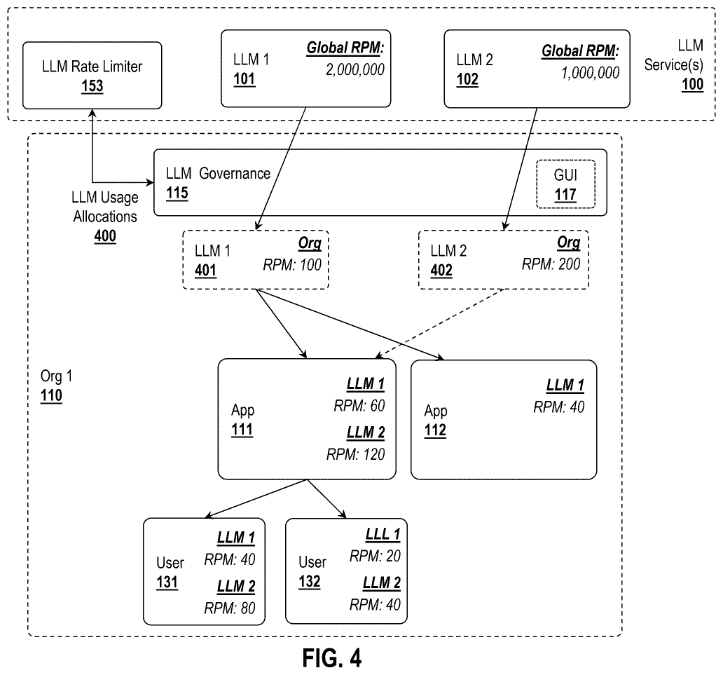

As illustrated in FIG. 4, based on the recommendations generated by the LLM assignment adviser 151 and/or the configuration specified by an administrator via a UI 117, 118 the LLM usage allocations 400 are enforced by the LLM governance engine 115 within the corresponding organization 110. In the illustrated example, allocations are made in the form of requests per minute (RPM), first at the organization level, then at the application level, and then at the user level. In FIG. 4, for example, LLM1 101 support a global RPM of 2,000,000, of which 100 RPM is allocated to organization 110, as indicated by local LLM1 allocation 401. Similarly, LLM2 102 supports a global RPM of 1,000,000, of which 200 RPM is allocated to organization 110, as indicated by local LLM2 allocation 402. These local LLM allocations 401-402 represent the total LLM resources available (specified in RPM) which can be allocated across applications 111-112 and users 131-132 within the organization 110. In this example, application 111 is allocated 60 RPM for accessing LLM1 101 and 120 RPM for LLM2 102, and application 112 is allocated 40 RPM for LLM1 101.

The allocation to each application 111-112 is then subdivided among users of that application. For example, user 131 of application 111 is allocated 40 RPM for LLM1 101 and user 132 is allocated the remaining 20 RPM for LLM1 101. Similarly, user 131 is allocated 80 RPM for LLM2 102 and user 132 is allocated the remaining 40 RPM for LLM2 102. Thus, the RPM allocation for each LLM within an organization is first partitioned among that organization's applications and then partitioned among users of the applications.

While separate sets of applications and users are associated with each organization in the examples described above, separate instances of the same application may be run within each organization. Similarly, certain users may be associated with multiple organizations (e.g., when each organization is associated with a different division or branch of the same company).

By way of example, and not limitation, using the same two LLMs, LLM1 101 and LLM2 102 (e.g., GPT4 and Mistral), and assuming two organizations, Org 1 and Org 2: Org 1 may run an instance of Application 1, Application 2, and may provide access to User 1 and User 2 and Org 2 may run an instance of Application 2 (i.e., the same application type in both orgs) and Application 3, and allow access to User 1 (i.e., the same user with access to both orgs) and User 3. The applications may be dedicated AI applications or other types of business applications configured to access the LLM services as described herein. In this implementation, the per-organization limits will be applied in the same manner as described above. Thus, Application 2 will receive a particular RPM allocation in Org 1 and another RPM allocation in Org 2. Similarly, User 1 will receive a first set of RPM allocations for applications in Org 1 and a second set of RPM allocations for applications in Org 2.

While the embodiments described above specify limits in terms of RPM, these embodiments may also specify limits based on tokens per minute (TPM). The global RPM or TPM limit at the LLM level is already set by the LLM provider. In FIG. 4, they are set at 2,000,000 RPM and 1,000,000 RPM for LLM1 101 and LLM2 102, respectively, for all organizations in the corresponding company (assuming a single company with multiple organizations). As such, these values are partitioned between the various organizations, based on the requirements of the organizations. In some embodiments, the RPM and TPM limits for within an organization 110 can only be set by the LLM governance engine 115 and corresponding UI 117 within that organization. The LLM governance engine 115 also sets the RPM and/or TPM limits for applications 111 and 112 in that organization 110.

In these embodiments, the combination of limits cannot exceed what has been assigned. For example, the combined RPM rate of applications 111 and 112 for LLM1 101 cannot exceed 100 in the example shown in FIG. 4. Similarly, The LLM governance engine 115 can also set RPM and TPM limits for users 131 and 132, and the combination of user limits cannot exceed what has been assigned. For example, the combined RPM rate of users 131 and 132 for LLM1 101 for application 111 cannot exceed 60.

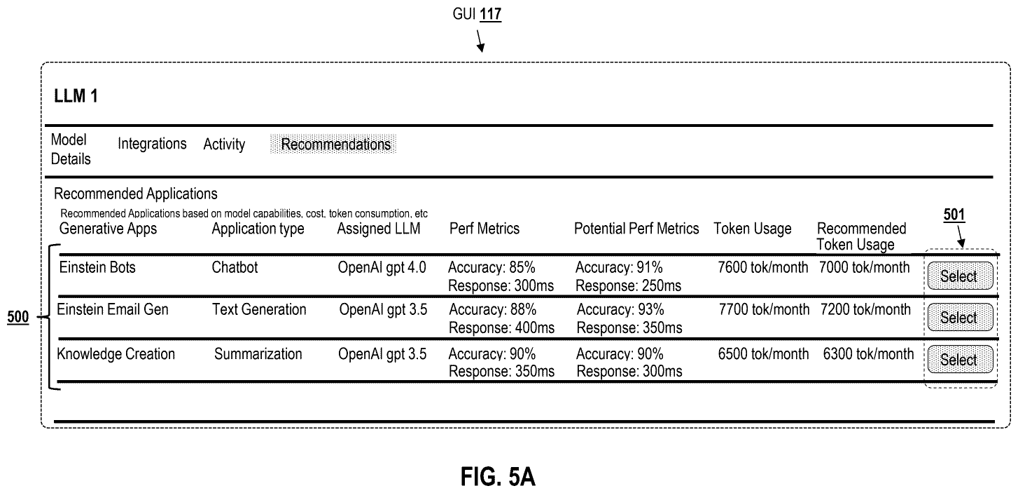

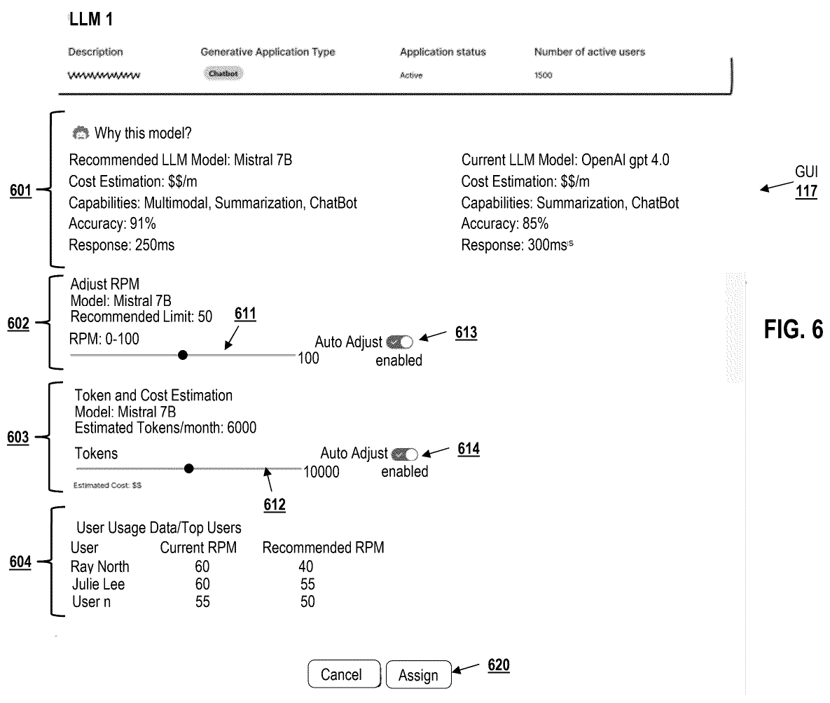

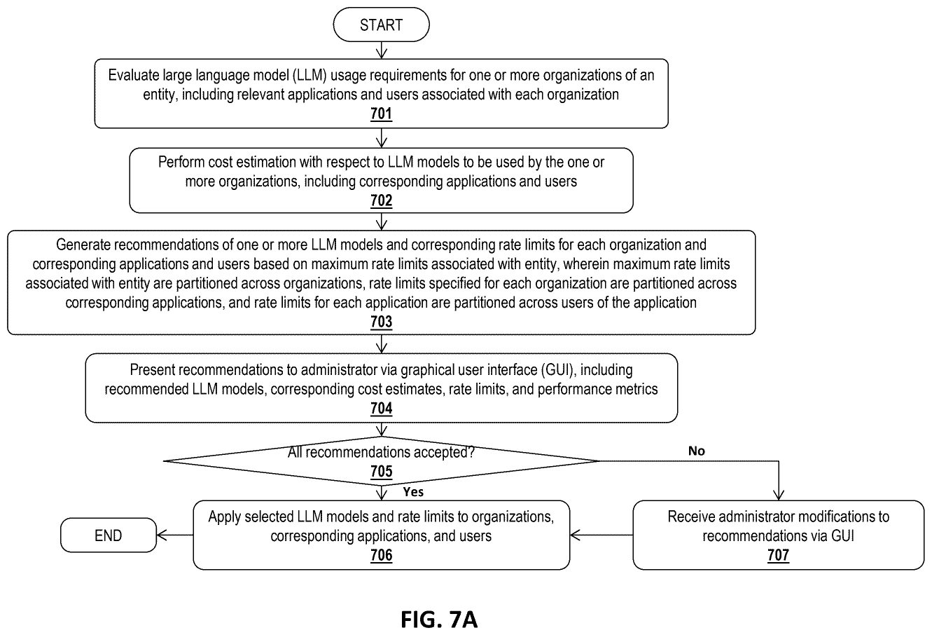

FIG. 5A illustrates an example portion of a graphical user interface (GUI) 117 for providing recommendations related to which applications or types of applications are a best match for a given LLM (LLM1 in the example). Information related to a set of generative apps 500 is displayed in a corresponding set of rows. Relevant information is provided for each application including the application type (e.g., chatbot, text generation, summarization), the currently assigned LLM (e.g., OpenAI gpt 3.5/4.0), performance metrics associated with the current LLM assignment (e.g., in the form of a percentage accuracy and average response times), the potential performance metrics if the new LLM (LLM1) is selected in place of the current LLM (e.g., also using accuracy percentages and average response times), current token usage for the assigned LLM, and recommended token usage for the new LLM (LLM1). Each row also includes a graphical selection element 501 which, when selected, presents additional details associated with the corresponding application and/or the new LLM (an example of which is described below with respect to FIG. 7).

FIG. 5B illustrates another example portion of the GUI 117 generated to provide recommendations with respect to a particular application (APP 1 in the example). The recommendations are provided in a set of rows, with each row associated with a specific task of the application. The tasks in this example are defined in prompt templates such as an introduction message (e.g., generating an introductory email), follow up (e.g., generating a follow up message), and knowledge creation (e.g., learning based on data extracted from a sequence of interactions). Relevant information is specified in each row including the prompt type (e.g., sales email, field generation, Flex), the currently assigned LLM (e.g., OpenAI gpt 3.5/4.0), the recommended LLM ((e.g., OpenAI gpt 3.5/4.0), current performance metrics (e.g., using a percentage accuracy and/or average response time), potential performance metrics, which are expected if the user chooses the recommended LLM, current token usage with the current LLM and recommended token usage (e.g., expected if the user updates to the recommended LLM). As in FIG. 5A, each row includes a graphical selection element 511 which, when selected, presents additional details associated with the corresponding application and/or new LLM.

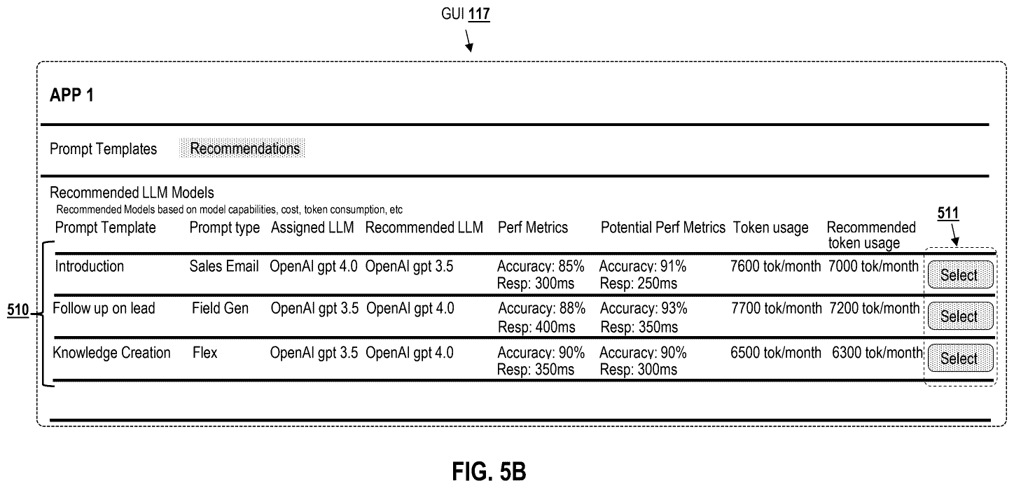

FIG. 6 illustrates an example GUI 117 associated with a recommended LLM, which displays more detailed information upon user selection of one of the graphical selection elements 501 or 511. A first region 601 provides a summary and comparison of the metrics associated with the current LLM and the recommended LLM (e.g., including LLM model, cost estimates, capabilities, accuracy, and response time). A second region 602 allows a user to adjust the RPM for the recommended LLM, using a graphical sliding element 611 which can be selected and moved along the range (e.g., from 0-100) and which includes a corresponding switch element 613 to enable/disable automatic adjustment of the RPM (e.g., based on evaluations performed by the LLM governance engine 115 and/or the LLM management engine 150 as described above).

A third region 603 provides information related to expected token usage and cost estimation, with another graphical sliding element 612 to manually adjust the number of allocated tokens and another switch element 614 to allow the number of tokens to be automatically selected (e.g., based on evaluations performed by the LLM governance engine 115 and/or the LLM management engine 150 as described above).

A fourth region 604 displays a list of the users with the largest RPM values (e.g., who access the LLM services most frequently). For each user, a current RPM and a recommended RPM value are provided. The recommended RPM may be automatically enforced in accordance with some embodiments, once the administrator selects the assign selection button 620 to assign the recommended LLM to the corresponding application and tasks.

A method in accordance with one embodiment of the invention is illustrated in FIG. 7A. The method may be implemented within the context of the various system and device architectures described herein, but is not limited to these specific implementations.

At 701, large language model (LLM) usage requirements are evaluated for one or more organizations of an entity (e.g., such as a business entity, educational entity, governmental entity, or any other type of entity), including relevant applications and users associated with each organization.

At 702, a cost estimation is performed with respect to LLM models which can potentially be used (or which are already being used) by the one or more organizations, including corresponding applications and users.

At 703, recommendations are generated, identifying one or more LLM models and corresponding rate limits for each organization, corresponding applications, and users. In some embodiments, the recommendations of specific LLM models are based on an analysis of the requirements of each organization, application, and user. Other variables for identifying appropriate LLM models may include, for example, the relevant industry or sub-Industry, the geographical region and language, the number of users (e.g., employees), the currently deployed products and current budget, and any previous assignments.

The rate limits may be based on total maximum rate limits specified for the entity. As mentioned, the total rate limits may be partitioned across the various organizations. The rate limit specified for each organization are then partitioned across corresponding applications under that organization, and the rate limits for each application may be partitioned across users of the application (e.g., as visually illustrated in FIG. 4).

At 704, the recommendations are presented to an administrator via a graphical user interface (GUI) (e.g., such as shown in FIGS. 5-6), including recommended LLM models for each application, corresponding cost estimates, rate limits, and performance metrics. For all of these variables, any existing LLM values may be presented for a side-by-side comparison with the expected values associated with the recommended LLMs.

If all of the recommendations are accepted/authorized, at 705, then at 706, the selected LLM models are applied and rate limits set as recommended for each organization, application, and user. Alternatively, the GUI may provide selectable options to allow an administrator to make modifications to the recommendations via the GUI (e.g., such as described with respect to FIG. 7). At 707, the administrator modifications are received and applied at 706.

FIG. 7B illustrates a method for dynamically reallocating spare rate limit allocations (e.g., remaining TPM or RPM amounts) between organizations, applications, and users. At 700, the initial RPM/TPM allocations are made to organizations, applications, and users as described above.

If an allocated RPM/TPM threshold is reached by an organization, application, or user, determined at 711, then some implementations will attempt to acquire spare RPM/TPM allocations from a different organization, application, or user. If spare RPM/TPM is available, then at 713, the spare RPM/TPM resource is reallocated to the organization, application, or user which has reached the threshold, subtracting the amount from the organization, application, or user with the spare TPM/RPM. If, at 712, there is no spare RPM/TPM available, then at 714, an administrator may be notified so that they can evaluate the situation (e.g., and potentially allocate more TPM/RPM resources if required).

The embodiments of the invention provide several unique features including, but not limited to, a recommendation engine which recommends which model should be assigned to each application as well as each user. Moreover, these embodiments provide a graphical user interface for visually assigning rate limits (RPMs and TPMs) to an application and user and presenting spare RPM capacity to an administrator. In addition, the GUI allows an administrator to view how the capacity propagates down from applications to users within each organization.

### Example Electronic Devices and Environments

### Electronic Device and Machine-Readable Media

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals-such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

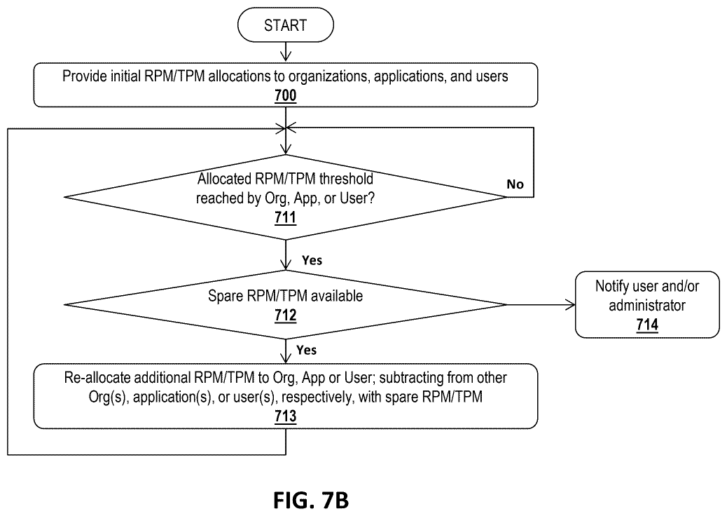

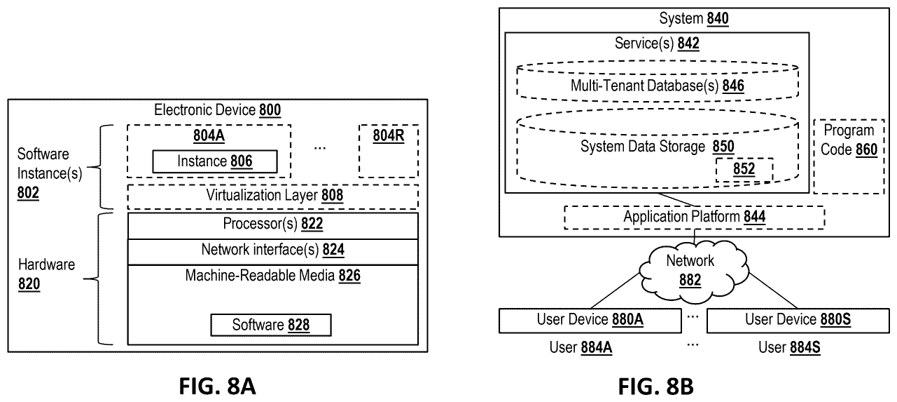

FIG. 8A is a block diagram illustrating an electronic device 800 according to some example implementations. FIG. 8A includes hardware 820 comprising a set of one or more processor(s) 822, a set of one or more network interfaces 824 (wireless and/or wired), and machine-readable media 826 having stored therein software 828 (which includes instructions executable by the set of one or more processor(s) 822). The machine-readable media 826 may include non-transitory and/or transitory machine-readable media to be executed by one or more electronic devices 900, such as server hardware (comprising a memory and a plurality of execution cores). Some of the components described above, enter into transactions with other components through a request-response protocol (e.g., such as request sent to access the LLM service(s) 100 via the API 190). In this arrangement, a component sending a request is a “client” with respect to that transaction and the component providing the response is the “server”. Various components described herein may perform the role of client and server (depending on whether they are sending a request or receiving a request and providing a response). In one implementation: 1) each of the components is implemented in a separate one of the electronic devices 800; 2) each component is implemented in a separate set of one or more of the electronic devices 800 (e.g., a set of one or more server devices where the software 828 represents the functional modules described herein software to implement the corresponding functions); and 3) in operation, the electronic devices implementing the components would be communicatively coupled (e.g., by a network) and would establish between them (or through one or more other layers and/or or other services) connections for communicating requests and receiving responses as described herein. Other configurations of electronic devices may be used in other implementations.

During operation, an instance of the software 828 (illustrated as instance 806 and referred to as a software instance; and in the more specific case of an application, as an application instance) is executed. In electronic devices that use compute virtualization, the set of one or more processor(s) 822 typically execute software to instantiate a virtualization layer 808 and one or more software container(s) 804A-804R (e.g., with operating system-level virtualization, the virtualization layer 808 may represent a container engine (such as Docker Engine by Docker, Inc. or rkt in Container Linux by Red Hat, Inc.) running on top of (or integrated into) an operating system, and it allows for the creation of multiple software containers 804A-804R (representing separate user space instances and also called virtualization engines, virtual private servers, or jails) that may each be used to execute a set of one or more applications; with full virtualization, the virtualization layer 808 represents a hypervisor (sometimes referred to as a virtual machine monitor (VMM)) or a hypervisor executing on top of a host operating system, and the software containers 804A-804R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 828 is executed within the software container 804A on the virtualization layer 808. In electronic devices where compute virtualization is not used, the instance 806 on top of a host operating system is executed on the “bare metal” electronic device 800. The instantiation of the instance 806, as well as the virtualization layer 808 and software containers 804A-804R if implemented, are collectively referred to as software instance(s) 802.

Alternative implementations of an electronic device may have numerous variations from that described above. For example, customized hardware and/or accelerators might also be used in an electronic device.

### Example Environment

FIG. 8B is a block diagram of a deployment environment according to some example implementations. A system 840 includes hardware (e.g., a set of one or more server devices) and software to provide service(s) 842, including the LLM services, LLM governance engines 115-116, and other components of the organizations 110, 120. In some implementations the system 840 is in one or more datacenter(s). These datacenter(s) may be: 1) first party datacenter(s), which are datacenter(s) owned and/or operated by the same entity that provides and/or operates some or all of the software that provides the service(s) 842; and/or 2) third-party datacenter(s), which are datacenter(s) owned and/or operated by one or more different entities than the entity that provides the service(s) 842 (e.g., the different entities may host some or all of the software provided and/or operated by the entity that provides the service(s) 842). For example, third-party datacenters may be owned and/or operated by entities providing public cloud services (e.g., Amazon.com, Inc. (Amazon Web Services), Google LLC (Google Cloud Platform), Microsoft Corporation (Azure)).

The system 840 is coupled to user devices 880A-880S over a network 882. The service(s) 842 may be on-demand services that are made available to one or more of the users 884A-884S working for one or more entities other than the entity which owns and/or operates the on-demand services (those users sometimes referred to as outside users) so that those entities need not be concerned with building and/or maintaining a system, but instead may make use of the service(s) 842 when needed (e.g., when needed by the users 884A-884S). The service(s) 842 may communicate with each other and/or with one or more of the user devices 880A-880S via one or more APIs (e.g., a REST API). In some implementations, the user devices 880A-880S are operated by users 884A-884S, and each may be operated as a client device and/or a server device. In some implementations, one or more of the user devices 880A-880S are separate ones of the electronic device 800 or include one or more features of the electronic device 800.

In some implementations, the system 840 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 840 is a multi-tenant cloud computing architecture supporting multiple services, such as one or more of the following types of services: Pricing; Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Cache-as-a-Service (CaaS); Analytics; Community; Internet-of-Things (IOT); Industry-specific; Artificial intelligence (AI); Application marketplace (“app store”); Data modeling; Security; and Identity and access management (IAM).

For example, system 840 may include an application platform 844 that enables PAAS for creating, managing, and executing one or more applications developed by the provider of the application platform 844, users accessing the system 840 via one or more of user devices 880A-880S, or third-party application developers accessing the system 840 via one or more of user devices 880A-880S.

In some implementations, one or more of the service(s) 842 may use one or more multi-tenant databases 846, as well as system data storage 850 for system data 852 accessible to system 840. In certain implementations, the system 840 includes a set of one or more servers that are running on server electronic devices and that are configured to handle requests for any authorized user associated with any tenant (there is no server affinity for a user and/or tenant to a specific server). The user devices 880A-880S communicate with the server(s) of system 840 to request and update tenant-level data and system-level data hosted by system 840, and in response the system 840 (e.g., one or more servers in system 840) automatically may generate one or more Structured Query Language (SQL) statements (e.g., one or more SQL queries) that are designed to access the desired information from the multi-tenant database(s) 846 and/or system data storage 850.

In some implementations, the service(s) 842 are implemented using virtual applications dynamically created at run time responsive to queries from the user devices 880A-880S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 860 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 844 includes an application setup mechanism that supports application developers' creation and management of applications, which may be saved as metadata by save routines. Invocations to such applications may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 882 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4th generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 840 and the user devices 880A-880S.

Each user device 880A-880S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 840. For example, the user interface device can be used to access data and applications hosted by system 840, and to perform searches on stored data, and otherwise allow one or more of users 884A-884S to interact with various GUI pages that may be presented to the one or more of users 884A-884S. User devices 880A-880S might communicate with system 840 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 880A-880S might include an HTTP client, commonly referred to as a “browser,” for sending and receiving HTTP messages to and from server(s) of system 840, thus allowing users 884A-884S of the user devices 880A-880S to access, process and view information, pages and applications available to it from system 840 over network 882.

### CONCLUSION

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims.

1. A method implemented in a set of one or more electronic devices to generate and enforce limits on usage of a plurality of large language models (LLM), the method comprising:
evaluating LLM model usage requirements of one or more organizations of an entity, including applications and users associated with each organization, wherein the organizations include a first organization, wherein the evaluating includes determining, for the applications associated with the first organization or a subset thereof, types of LLM requests required to be serviced, each of the types of LLM requests associated with a different expected number of tokens per minute (TPM) and/or requests per minute (RPM);
performing a cost estimation with respect to expected utilization of the plurality of LLM models by the one or more organizations and, the applications;
determining a respective recommended subset of LLM models from the plurality of LLM models for each of the one or more organizations based on the usage requirements and the cost estimation,
determining respective recommended threshold rate limits, in terms of TPM and/or RPM, for each organization and the associated applications based on a global threshold rate limit specified for the entity;
providing the recommended subset of LLM models and rate limits for the first organization to an administrator, including options for accepting the recommended subset of LLM models and the rate limits and/or modifying one or more of the recommended subset of LLM models and/or rate limits, wherein responsive to the administrator accepting the recommendations with modifications or without modifications:
allocating the first organization a threshold rate limit partitioned from the global threshold rate limit;
subdividing the threshold rate limit into portions to be allocated to respective ones of the applications associated with the first organization;
subdividing the portions into corresponding sub-portions to be allocated to users that are associated with the first organization and that use the respective ones of the applications;
tracking runtime LLM usage by each organization, application, and user; and
individually enforcing respective threshold rate limits allocated to the one or more organizations, including enforcing for the first organization the corresponding portion allocated to each of the respective ones of the applications, and the corresponding sub-portions allocated to the users, wherein the threshold rate limits manage load and enable efficient operation of the plurality of LLM models, thereby preventing overloading and ensuring that the plurality of LLM models can efficiently process incoming requests and provide responses.

2. The method of claim 1, further comprising:
presenting the cost estimation with respect to expected utilization of the subset of LLM models recommended for the first organization.

3. The method of claim 1, wherein individually enforcing the respective threshold rate limits is performed by a respective LLM governance engines operable within the corresponding organization.

4. (canceled)

5. The method of claim 14, further comprising:
detecting that a threshold RPM or threshold TPM has been reached by one of the organizations, applications, or users;
determining if spare RPM or spare TPM resources are available from other organizations, applications, or users; and
responsively reallocating at least a portion of the spare RPM or spare TPM resources to the one of the organizations, applications, or users.

6. The method of claim 1, wherein providing the recommended subset of LLM models and rate limits for the first organization to an administrator comprises presenting the recommended subset of LLM models and rate limits for the first organization in a graphical user interface (GUI) to be accessed by the administrator, the GUI to provide options for accepting the recommended subset of LLM models and the rate limits and/or modifying one or more of the recommended subset of LLM models and rate limits.

7. The method of claim 6, wherein the GUI is to present a listing of applications which are suited for a corresponding recommended LLM, the listing comprising a set of entries, each entry corresponding to a different one of the applications.

8. The method of claim 7, wherein each entry is to provide an indication of one or more of: a type of the corresponding application, a currently assigned LLM model, if any, current performance metrics associated with the currently assigned LLM model, potential performance metrics corresponding to the recommended LLM model, current token or request metrics associated with the currently assigned LLM model, and recommended token or request metrics corresponding to the recommended LLM model.

9. The method of claim 8, wherein each entry is to further provide a selectable graphical element which, when selected, is to cause the GUI to display additional relevant information related to the application, the current LLM model, and the recommended LLM model, and is to provide a plurality of options for the administrator to adjust specified parameters for operation.

10. The method of claim 9, wherein a first option of the plurality of options comprises an input region for adjusting TPM or RPM values associated with the corresponding application and a second option to enable automatic adjustment of the TPM or RPM values by an LLM governance engine operable in the organization.

11. A non-transitory machine-readable storage medium having program code stored thereon which, when executed by one or more electronic devices, are to cause the one or more electronic devices to generate and enforce limits on usage of a plurality of large language models (LLM) by performance of operations comprising:
evaluating LLM model usage requirements of one or more organizations of an entity, including applications and users associated with each organization, wherein the organizations include a first organization, wherein the evaluating includes determining, for the applications associated with the first organization or a subset thereof, types of LLM requests required to be serviced, each of the types of LLM requests associated with a different expected number of tokens per minute (TPM) and/or requests per minute (RPM);
performing a cost estimation with respect to expected utilization of the plurality of LLM models by the one or more organizations and the, associated applications;
determining a respective recommended subset of LLM models from the plurality of LLM models for each of the one or more organizations, based on the usage requirements and the cost estimation,
determining respective recommending-rate limits, in terms of TPM and/or RPM, for each organization and the associated applications based on a global threshold rate limit specified for the entity;
providing the recommended subset of LLM models and rate limits for the first organization to an administrator, including options for accepting the recommended subset of LLM models and the rate limits and/or modifying one or more of the recommended subset of LLM models and/or rate limits, wherein responsive to the administrator accepting the recommendations with modifications or without modifications:
allocating the first organization a threshold rate limit partitioned from the global threshold rate limit;
subdividing the threshold rate limit into portions to be allocated to respective ones of the applications associated with the first organization;
subdividing the portions into corresponding sub-portions to be allocated to users that are associated with the first organization and that use the respective ones of the applications;
tracking runtime LLM usage by each organization, application, and user; and
individually enforcing respective threshold rate limits allocated to the one or more organizations, including enforcing for the first organization the corresponding portion allocated to each of the respective ones of the applications, and the corresponding sub-portions allocated to the users of the respective application, wherein the threshold rate limits manage load and enable efficient operation of the plurality of LLM models, thereby preventing overloading and ensuring that the plurality of LLM models can efficiently process incoming requests and provide responses.

12. The non-transitory machine-readable storage medium of claim 11,
further comprising program code to cause the one or more electronic devices to perform the operations of:
presenting the cost estimation with respect to expected utilization of the subset of LLM models recommended for the first organization.

13. The non-transitory machine-readable storage medium of claim 11,
wherein individually enforcing the respective threshold rate limits is performed by a respective LLM governance engine operable within the corresponding organization.

14. (canceled)

15. The non-transitory machine-readable storage medium of claim 14,
further comprising program code to cause the one or more electronic devices to perform the operations of:
detecting that a threshold RPM or threshold TPM has been reached by one of the organizations, applications, or users;
determining if spare RPM or spare TPM resources are available from other organizations, applications, or users; and
responsively reallocating at least a portion of the spare RPM or spare TPM resources to the one of the organizations, applications, or users.

16. The non-transitory machine-readable storage medium of claim 11, wherein providing the recommended subset of LLM models and rate limits for the first organization to an administrator comprises presenting the recommended subset of LLM models and rate limits in a graphical user interface (GUI) to be accessed by the administrator, the GUI to provide options for accepting the recommended subset of LLM models and the rate limits and/or modifying one or more of the recommended subset of LLM models and rate limits.

17. The non-transitory machine-readable storage medium of claim 16, wherein the GUI is to present a listing of applications which are suited for a corresponding recommended LLM, the listing comprising a set of entries, each entry corresponding to a different one of the applications.

18. The non-transitory machine-readable storage medium of claim 17, wherein each entry is to provide an indication of one or more of: a type of the corresponding application, a currently assigned LLM model, if any, current performance metrics associated with the currently assigned LLM model, potential performance metrics corresponding to the recommended LLM model, current token or request metrics associated with the currently assigned LLM model, and recommended token or request metrics corresponding to the recommended LLM model.

19. The non-transitory machine-readable storage medium of claim 18, wherein each entry is to further provide a selectable graphical element which, when selected, is to cause the GUI to display additional relevant information related to the application, the current LLM model, and the recommended LLM model, and is to provide a plurality of options for the administrator to adjust specified parameters for operation.

20. The non-transitory machine-readable storage medium of claim 19, wherein a first option of the plurality of options comprises an input region for adjusting TPM or RPM values associated with the corresponding application and a second option to enable automatic adjustment of the TPM or RPM values by an LLM governance engine operable in the organization.
